(19) United States
(12) Patent Application Publication
(10) Pub. No.: US 2025/0128944 A1
(43) Pub. Date: Apr. 24, 2025

(54) OXIDATION REACTOR FOR PARTIAL OXIDATION OF A FEED STREAM WITH SPECIFIC GEOMETRY

(71) Applicant: L'Air Liquide, Societe Anonyme pour l'Etude et l’Exploitation des Procedes Georges Claude, Paris (FR)

(72) Inventor: Antonio COSCIA, Frankfurt am Main (DE)

(21) Appl. No.: 18/919,414

(22) Filed: Oct. 17, 2024

(30) Foreign Application Priority Data
Oct. 20, 2023 (EP) EP 23204773.8

(51) Int. Cl. C01B 3/36

(52) U.S. Cl. CPC C01B 3/363; B01J 2219/0218; C01B 2203/0227; C01B 2203/0255; C01B 2203/1241

(57) ABSTRACT

The invention relates to an oxidation reactor for partial oxidation of a feed stream with an oxygen-containing oxidant stream to give a hydrogen-containing product stream. This partial oxidation may be conducted as a noncatalytic partial oxidation (POX) or as an autothermal reforming (ATR). Useful feed streams here include hydrocarbonaceous streams, but also ammonia-containing streams. According to the invention, the inlet region of the oxidation reactor is configured as a combination of a dome-shaped region with a (frusto) conical region, where the (frusto) conical inlet region merges into the cylindrical section of the oxidation reactor.

### CROSS-REFERENCE TO RELATED APPLICATIONS

This application claims the benefit of priority under 35 U.S.C. § 119 (a) and (b) to EP patent application No. EP 23204773.8, filed Oct. 20, 2023, the entire contents of which are incorporated herein by reference.

### BACKGROUND

### Field of the Invention

The invention relates to an oxidation reactor for partial oxidation of a feed stream with an oxygen-containing oxidant stream to give a hydrogen-containing product stream. This partial oxidation may be conducted as a noncatalytic partial oxidation (POX) or as an autothermal reforming (ATR). Useful feed streams here include hydrocarbonaceous streams, but also ammonia-containing streams.

The invention further relates to a process for producing a crude synthesis gas stream from a feed stream containing hydrocarbons and an oxygen-containing oxidant stream by noncatalytic partial oxidation or by autothermal reforming, and to a process for producing a hydrogen- and nitrogen-containing product stream from an ammonia-containing product stream and an oxygen-containing oxidant stream. The invention further relates to corresponding uses of the oxidation reactor proposed.

### Prior Art

Synthesis gases are gas mixtures containing hydrogen and carbon oxides which are used in various synthesis reactions. Examples thereof are methanol synthesis, the production of ammonia by the Haber-Bosch process or Fischer-Tropsch synthesis. Conventional routes for production of hydrogen-containing synthesis gases include steam reforming, autothermal reforming (ATR) and noncatalytic partial oxidation (POX), in each case using hydrocarbonaceous feed materials as reactant streams. ATR and POX are conducted in oxidation reactors of similar construction that differ essentially by the presence of a catalyst layer in the lower portion of the oxidation reactor in the autothermal reformer.

The partial oxidation of hydrocarbonaceous feed material for production of synthesis gas is typically performed at high reactor temperatures in the range from 1000° C. to 1500° C. and pressures of up to 100 bara. Oxidation reactors used for noncatalytic partial oxidation (POX reactors) are often refractory lined reactors with hemispherical or virtually hemispherical domes. The partial oxidation burner (POX burner) is generally mounted at the top of the dome, preferably at the pole thereof, and serves for introduction of the hydrocarbonaceous feed material, the oxygen-containing oxidant and—optionally—one or more moderator streams.

The industrial processes and apparatuses for partial oxidation known from the prior art propose various apparatuses for introducing and mixing the various streams, i.e. the hydrocarbonaceous feed material, a generally oxygen-containing oxidant and sometimes a moderator. The moderator used is frequently carbon dioxide (CO₂) or steam, where the moderator is separately introduced into the reactor via a separate channel within the burner or admixed with one or more of the other feed streams upstream of the burner. The oxidant used is typically air, oxygen-enriched air or pure oxygen with at least 95 mol % of oxygen. In one example, a hydrocarbonaceous feed stream is a stream containing hydrocarbons such as methane or higher hydrocarbons or other hydrogen- and carbon-containing molecules, for example alcohols such as methanol or ethanol. This may also be a stream which is obtained from an upstream primary reformer and contains not only carbon monoxide (CO), hydrogen (H₂), carbon dioxide (CO₂) and water (H₂O) but also hydrocarbons such as methane, ethane, ethylene or higher hydrocarbons such as benzene, toluene or xylenes. The hydrocarbonaceous feed material and the oxidant are generally mixed in a reactor in close proximity to the injection nozzles.

The basic construction and the use of oxidation reactors of the type described are known per se from the literature and are described, for example, in the article “Gas Production”, Ullmann's Encyclopedia of Industrial Chemistry, Sixth Edition, 1998 Electronic Release, in chapter 2.5 “Autothermal Catalytic Reforming” and chapter 3 “Noncatalytic Partial Oxidation”. Both reactor types have a pressure-related reactor shell which is made of a generally metallic material and which is lined on its inside with one or more layers of refractory material, for example refractory bricks, which thus form protective layers against the heat released in the reactor interior and against any corrosive gas constituents.

Another output stream for production of a hydrogen-containing gas which is proposed in the more recent literature is an ammonia-containing feed stream, which is reacted with an oxygen-containing oxidant stream and optionally a steam stream to give a hydrogen-containing product gas. This reaction can in turn be effected, for example, by the principle of noncatalytic partial oxidation or by the principle of autothermal reforming in respectively suitable oxidation reactors.

The oxidation reactors known from the prior art, especially POX reactors or autothermal reformers, often have an inlet region configured as a cone or frustocone on the one hand or as a dome on the other hand.

Each of the designs has specific advantages and disadvantages:
The transition from a small to a large diameter can be achieved over a much shorter length in the case of a dome-shaped inlet region compared to a (frusto) conical inlet region, which-given a constant height and equal diameter of the reactor-enables oxidation reactors having a relatively long cylindrical shell section. This results in improved mixing of the product gases in axial direction, and there are more options for the arrangement of an ATR catalyst.
A dome-shaped inlet region offers more flexibility in construction since, in the case of altered reactor and burner diameter, the dome can be adapted to a greater degree in terms of its geometry, whereas a (frusto) conical inlet region offers fewer degrees of freedom here since it is not possible to deviate from an extreme value for the angle of about 30° for structural or static reasons.
A (frusto) conical inlet region ensures a greater distance between the burner flame and the inner walls of the oxidation reactor, which reduces thermal and mechanical stress and wear to the refractory protective layer and impairs the flame geometry to a lesser degree since recirculation zones and turbulence that arise when jet flows occur close to an inner wall of an oxidation reactor are avoided.
The disadvantage of a dome-shaped inlet region is its limited diameter since, with increasing reactor diameter, the absorption of the mechanical stresses that result from the thermal expansion within the refractory protective layer of the inlet region becomes more complex, and the resulting comparatively major movement owing to the thermal expansion together with the increasing mechanical stresses and forces on the refractory protective layer has an adverse effect on the integrity and lifetime of the refractory finish.

### DESCRIPTION OF THE INVENTION

It is therefore an object of the present invention to specify an oxidation reactor for partial oxidation of a feed stream with an oxygen-containing oxidant stream to give a hydrogen-containing product stream, which does not have the mentioned disadvantages of the oxidation reactors that are known from the prior art, where specific benefits of the different designs should be retained as far as possible.

This object is achieved in a first aspect of the invention by an oxidation reactor having the features of claim 1.

In further aspects, the object is achieved by uses of the oxidation reactor having the features of claims 11 to 14.

In further aspects, the object is achieved by a process for producing a crude synthesis gas stream from a feed stream containing hydrocarbons and an oxygen-containing oxidant stream by noncatalytic partial oxidation according to claim 15, or by autothermal reforming according to claim 16, and by a process for producing a hydrogen- and nitrogen-containing product stream from an ammonia-containing product stream and an oxygen-containing oxidant stream according to claim 17 or by means of autothermal reforming according to claim 18.

In further aspects, the object is achieved by further configurations of the invention that will be apparent from the dependent claims of the respective category.

An oxygen-containing oxidant means any oxygen-containing fluid, for example pure oxygen in any purity, air or any other fluid capable of supplying oxygen to a reactant.

A means is an article which makes it possible to achieve, or is helpful in achieving, an objective. Means of performing a particular process step should in particular be considered to mean all physical objects which a person skilled in the art would consider for performance of this process step. For example, a person skilled in the art will consider means of introducing or discharging a material stream to include all transporting and conveying apparatuses, i.e. for example pipe conduits, pumps, compressors, valves, which appear to be necessary or sensible for performance of this process step on the basis of their knowledge in the art.

In the context of the present description, steam is a synonym for water vapour, unless stated otherwise in the individual case. By contrast, the term “water” relates to water in the liquid state, unless stated otherwise in the individual case.

If required, pressures are specified in absolute pressure units, bara or bar (a) for short, or in gauge pressure units, barg or bar (g) for short, unless stated otherwise in the individual case.

A fluid connection between two regions of the apparatus or plant according to the invention means any type of connection which makes it possible for a fluid, for example a gas stream, to be able to flow from one to the other of the two regions, neglecting interposed regions or components. A direct fluid connection should in particular be considered to mean any type of connection which makes it possible for a fluid, for example a gas stream, to flow directly from one to the other of the two regions without any other interposed regions or components, except for pure transportation operations and the means required therefor, for example pipe conduits, valves, pumps, compressor, reservoirs. One example would be a pipe conduit leading directly from the one to the other of the two regions.

“Optionally” or “electively” means that the subsequently described event or circumstances may or may not occur or that a feature may or may not be present. The description encompasses cases in which the event or circumstance occurs and cases in which it does not occur. The description likewise encompasses cases in which a feature is present or is not present.

The conditions of non-catalytic partial oxidation and of autothermal reforming are known to the person skilled in the art from the prior art, for example the documents discussed at the outset. These are the physicochemical conditions under which a measurable, preferably an industrially relevant, conversion of fluid or fluidized carbon-containing feed streams to synthesis gas products is achieved. These include, as important parameters, the establishment of a suitable partial oxidation temperature of typically about 1000° C. or above. It is especially characteristic for noncatalytic partial oxidation that no catalyst is present in the partial oxidation reactor. By contrast, it is a characteristic feature of autothermal reforming that a layer of a specific ATR catalyst, but one which is known per se and commercially available, is present in the lower portion of the oxidation reactor.

Necessary adjustments of the conditions of the noncatalytic partial oxidation and of the autothermal reforming to the respective operating requirements will be made by the person skilled in the art on the basis of routine experiments. Any specific reaction conditions disclosed may serve as a guide, but should not be considered to be limiting in relation to the scope of the invention.

The terms “entry”, “inlet”, “exit” and “outlet” relate to the flow direction of the feed materials through the oxidation reactor.

The invention is based on the finding that the disadvantages of the oxidation reactors known to date from the prior art can be avoided when the inlet region of the oxidation reactor is configured as a combination of a dome-shaped first section preferably having the surface of a sphere segment with a (frusto) conical second section, where the (frusto) conical second section merges into a cylindrical third section of the oxidation reactor. All three sections are connected to one another in a gastight manner and are provided with at least one refractory protective layer on their inside. This makes it possible to combine the advantages of the two configurations and at the same time to overcome their given application limits for industrial scale applications.

The dome-shaped configuration of the inlet region is kept constant over the entire performance/size range of the oxidation reactor. The burner is disposed at the pole of the dome-shaped inlet region.

The (frusto) conical inlet region is configured with a defined slope angle. With a fixed diameter/height ratio of the oxidation reactor, only the length of the frustocone and the diameter of the cylindrical section have to be adjusted for enlargement of the scale thereof.

By virtue of the combination of a dome-shaped inlet region with a (frusto) conical inlet region, it is possible to keep the slope angle of the cone or frustocone much smaller compared to configurations according to the prior art, which increases the volume of the reactor and simultaneously minimizes the forces and stresses on the refractory protective layer.

### Preferred Embodiments of the Invention

A second aspect of the invention is characterized in that the first section (a1) is of hemispherical configuration, i.e. has a constant radius in longitudinal direction of the oxidation reactor that corresponds to a semicircle. Such a geometry exerts the smallest loads and forces on the inner refractory lining.

A third aspect of the invention is characterized in that the frustoconical second section (a2) has a slope angle between 5° and 30° inclusive, preferably between 10° and 20° inclusive, relative to the longitudinal axis, where the end values mentioned are included in the ranges of values. Studies show that, by virtue of these slope angles of the frustocone that are smaller in the case of configurations of oxidation reactors according to the prior art, the volume of the reactor can be increased and, at the same time, the forces and loads on the refractory protective layer can be minimized.

A fourth aspect of the invention is characterized in that the frustoconical second section (a2) has an internal diameter D1 at its narrow end and an internal diameter D2 at its wide end, where the ratio D1/D2 is between 0.7 and 0.9, preferably between 0.75 and 0.85. Studies show that these length ratios offer particular benefits.

A fifth aspect of the invention is characterized in that the slope of the dome-shaped first section corresponds to the slope of the frustoconical second section at a transition site of sections (a1) and (a2). In this way, vertices are avoided in the reactor shell and the inner refractory protective layer, which increases the mechanical stability of the apparatus and minimizes thermal stress at the joining site of sections (a1) and (a2).

A sixth aspect of the invention is characterized in that the reactor shell is surrounded by at least one cooling zone or cooling shell by means of which at least one section of the reactor shell is coolable by means of a fluid cooling medium. In this way, control of the oxidation reactor temperature is improved and the construction materials and components used in the oxidation reactor are subject to lower thermal stress.

A seventh aspect of the invention is characterized in that there are at least two cooling zones disposed along the longitudinal axis of the oxidation reactor. As a result, operation of the oxidation reactor can continue if, for example, merely an inspection or repair at a particular point in the reactor shell is required. In this case, it is only that cooling zone which surrounds the affected point in the reactor shell that is taken out of operation, and then disassembled. On completion of inspection or repair, this cooling zone is reassembled and put back into operation. Operation of the oxidation reactor can continue over the entire duration of the inspection or repair measures, such that production shutdowns are avoided.

It is also advantageous that the inventive presence of two or more cooling zones, for example two or more cooling zones disposed over the length of the oxidation reactor, enables better reaction to different production of heat along the longitudinal axis of the oxidation reactor. For instance, it would be possible in an illustrative configurations of the oxidation reactor as ATR to distinguish the heat budget in the upper burner portion of the oxidation reactor from that in the lower reactor portion comprising the ATR catalyst bed. With the inventive configuration of the oxidation reactor with multiple cooling zones, finer reaction to such differences is possible, and so the result is improved temperature control of the oxidation reactor.

An eighth aspect of the invention is characterized in that a common cooling medium flows through the at least two cooling zones, preferably with use of water as the common cooling medium. Water is available in sufficient volume and quality at most locations, is nontoxic, and has advantages if cooling is to be implemented in the form of evaporative cooling in the particular cooling zone. The use of a common cooling medium additionally simplifies the configuration of the coolant circuit.

A ninth aspect of the invention is characterized in that the at least two cooling zones are operable separately and can be assembled and disassembled separately. As a result, in one example, operation of the oxidation reactor can continue if, for example, merely an inspection or repair at a particular point in the reactor shell is required. Operation of the oxidation reactor can continue over the duration of the inspection or repair measures, such that production shutdowns are avoided.

A tenth aspect of the invention is characterized in that a portion of the reactor chamber is filled with a bed of a solid particulate catalyst active in respect of autothermal reforming (ATR).

An eleventh aspect of the invention relates to the use of an oxidation reactor according to claims 1 to 9 for noncatalytic partial oxidation (POX) of a feed stream containing hydrocarbons to a product stream containing hydrogen and carbon oxides.

A twelfth aspect of the invention relates to the use of an oxidation reactor according to claim 10 for autothermal reforming (ATR) of a feed stream containing hydrocarbons to a product stream containing hydrogen and carbon oxides.

A thirteenth aspect of the invention relates to the use of an oxidation reactor according to claims 1 to 9 for noncatalytic partial oxidation of an ammonia-containing feed stream to a hydrogen- and nitrogen-containing product stream.

An fourteenth aspect of the invention relates to the use of an oxidation reactor according to claim 10 for autothermal reforming of an ammonia-containing feed stream to a hydrogen- and nitrogen-containing product stream.

A fifteenth aspect of the invention relates to a process for producing a product stream containing hydrogen and carbon oxides from a feed stream containing hydrocarbons and an oxygen-containing oxidant stream by noncatalytic partial oxidation, comprising the following steps:
(a) providing an oxidation reactor according to claims 1 to 9;
(b) introducing the feed stream containing hydrocarbons, the oxygen-containing oxidant stream and an optional moderator stream via the burner into the reaction chamber;
(c) converting the feed stream containing hydrocarbons and the oxygen-containing oxidant stream in the burner and/or in the reactor chamber under conditions for noncatalytic partial oxidation (POX);
(d) discharging the product stream containing hydrogen and carbon oxides via the outlet.

A sixteenth aspect of the invention relates to a process for producing a product stream containing hydrogen and carbon oxides from a feed stream containing hydrocarbons and an oxygen-containing oxidant stream by autothermal reforming, comprising the following steps:
(a) providing an oxidation reactor according to claim 10;
(b) introducing the feed stream containing hydrocarbons, the oxygen-containing oxidant stream and an optional moderator stream via the burner into the reaction chamber;
(c) converting the feed stream containing hydrocarbons and the oxygen-containing oxidant stream in the burner and/or in the reactor chamber and/or in the catalyst bed under conditions for autothermal reforming (ATR);
(d) discharging the product stream containing hydrogen and carbon oxides via the outlet.

A seventeenth aspect of the invention relates to a process for producing a hydrogen- and nitrogen-containing product stream from an ammonia-containing feed stream and an oxygen-containing oxidant stream by noncatalytic partial oxidation, comprising the following steps:
(a) providing an oxidation reactor according to claims 1 to 9;
(b) introducing the ammonia-containing feed stream, the oxygen-containing oxidant stream and an optional moderator stream via the burner into the reaction chamber;
(c) converting the ammonia-containing feed stream and the oxygen-containing oxidant stream in the burner and/or in the reactor chamber under conditions for noncatalytic partial oxidation of ammonia;
(d) discharging the product stream containing hydrogen and nitrogen via the outlet.

An eighteenth aspect of the invention relates to a process for producing a product stream containing hydrogen and nitrogen from a feed stream containing ammonia and an oxygen-containing oxidant stream by autothermal reforming, comprising the following steps:
(a) providing an oxidation reactor according to claim 10;
(b) introducing the ammonia-containing feed stream, the oxygen-containing oxidant stream and an optional moderator stream via the burner into the reaction chamber;
(c) converting the ammonia-containing feed stream and the oxygen-containing oxidant stream in the burner and/or in the reactor chamber and/or in the catalyst bed under conditions for autothermal reforming (ATR);
(d) discharging the product stream containing hydrogen and nitrogen via the outlet.

### BRIEF DESCRIPTION OF THE FIGURES

Further developments, advantages and possible uses of the invention will also be apparent from the description of working examples that follows and the drawings. The invention is formed by all of the features described and/or depicted, either on their own or in any combination, irrespective of the way they are combined in the claims or the dependency references therein.

The figures show:

FIG. 1 a schematic diagram of a first configuration of the oxidation reactor as POX reactor according to the prior art;

FIG. 2 a schematic diagram of a second configuration of the oxidation reactor as ATR according to the prior art;

FIG. 3 a schematic diagram of a third configuration of the oxidation reactor as POX reactor according to the invention;

FIG. 4 a schematic diagram of a fourth configuration of the oxidation reactor as ATR according to the invention.

### DETAILED DESCRIPTION OF THE INVENTION

What is meant by “not shown” hereinafter is that an element in the figure under discussion is not represented graphically but is nevertheless present.

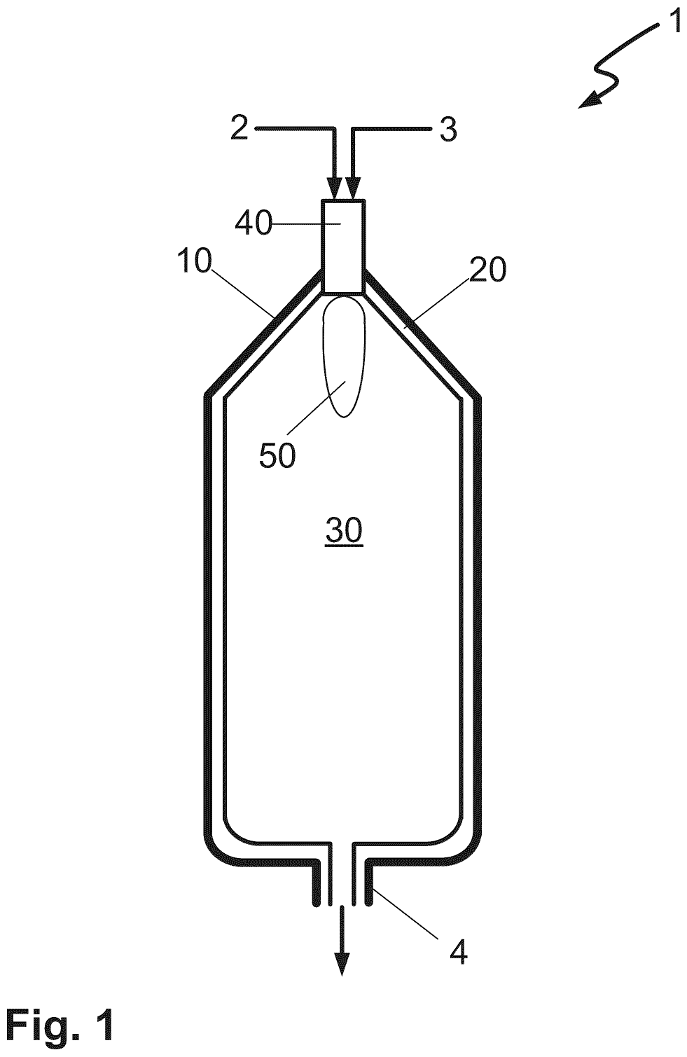

FIG. 1 shows a schematic diagram of a first configuration of the oxidation reactor 1 for partial oxidation of a feed stream with an oxygen-containing oxidant stream to give a hydrogen-containing product stream as POX reactor according to the prior art. The oxidation reactor comprises, in its upper portion, a frustoconical reactor shell 10 which merges further down into a cylindrical section.

At an inlet end of the reactor shell 10 is mounted an inlet for the feed stream, where the inlet is configured as a burner 40 through which a feed stream is introduced via a conduit 2, and an oxygen-containing oxidant stream via a conduit 3, into a void volume which is arranged within the reactor interior of the oxidation reactor 1 and serves as reactor chamber. In this case, a burner flame 50 is formed. It is optionally possible to introduce a moderator stream comprising steam and/or carbon dioxide into the oxidation reactor via conduit 2 or conduit 3 or a separate conduit which is not shown, or a combination of at least two of these conduits. In the reactor chamber, the feed stream is reacted with the oxygen-containing oxidant stream under conditions of noncatalytic partial oxidation (POX). The product stream formed here is discharged from the oxidation reactor 1 via an outlet 4 mounted at an outlet end of the reactor shell 10. All the described constituents of the oxidation reactor 1 have gastight connections to one another and are fluidically connected.

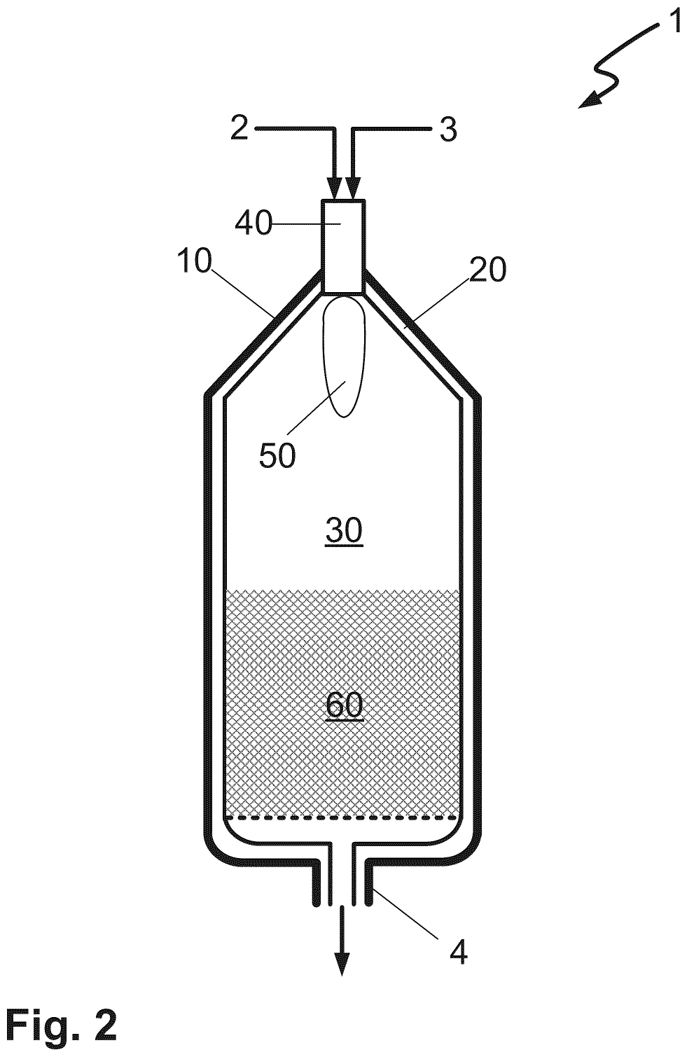

FIG. 2 shows a schematic diagram of a second configuration of the oxidation reactor according to the prior art as autothermal reformer. Identical reference numerals denote elements of the oxidation reactors shown in the figures that have the same function and structure, unless stated otherwise in the individual context. Fundamentally, the configurations shown in FIGS. 2, 3 and 4 correspond to those that were elucidated in association with FIG. 1; differences will be pointed out separately.

The configuration of the oxidation reactor 1 as ATR which is shown in FIG. 2 corresponds largely to the configuration shown in FIG. 1, except that a bed 60 of an ATR catalyst is now disposed in the lower portion of the reactor chamber 30. For operation of the oxidation reactor as an autothermal reformer, as well as the oxygen-containing oxidant, steam is introduced into the oxidation reactor via conduit 2 or conduit 3 or a separate conduit which is not shown, or a combination of at least two of these conduits.

The respective advantages and disadvantages of the reactors according to the prior art that are shown in FIG. 1 and FIG. 2 have already been elucidated above.

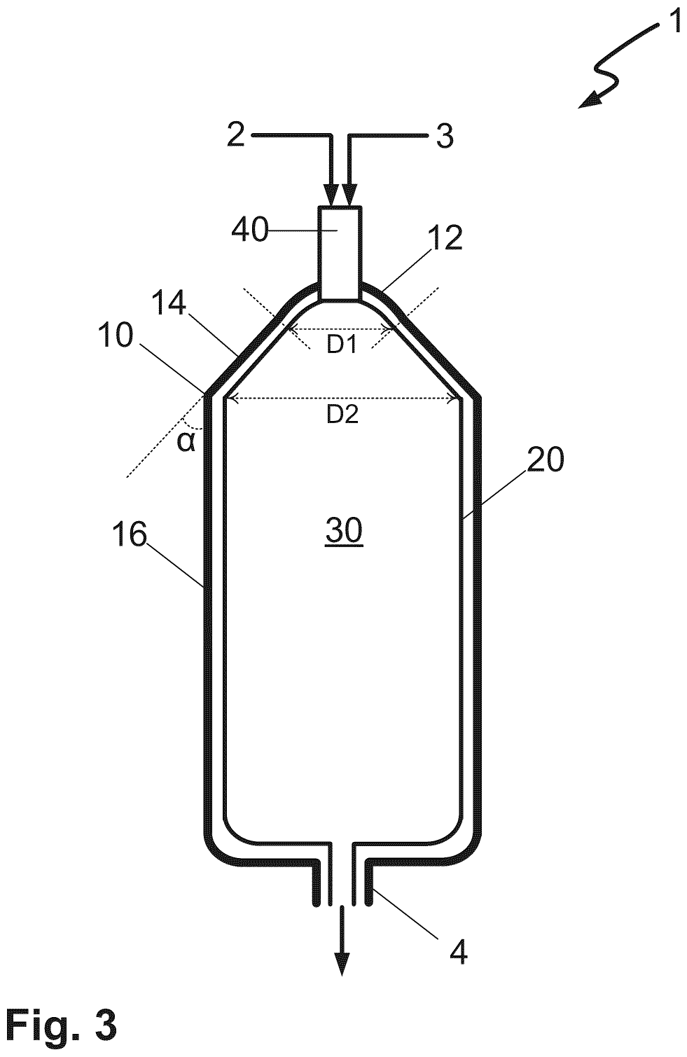

FIG. 3 shows a schematic diagram of a third configuration of the oxidation reactor as POX reactor according to the invention. The pressure-rated reactor shell 10 consists of a metallic material and comprises the following sections along the longitudinal axis:
(a1) a dome-shaped first section 12 that preferably has the surface of a sphere segment,
(a2) a frustoconical second section 14 having an internal diameter D1 at its narrow end and an internal diameter D2 at its wide end,
(a3) a cylindrical third section 16, wherein section (a1) has a gastight connection to section (a2), and section (a2) has a gastight connection to section (a3).

A protective layer 20 of a refractory and corrosion-resistant material is mounted inside the reactor shell 10. Within the protective layer there is a void volume 30 that serves as reactor chamber.

At the pole of the first section (a1) is mounted an inlet for a feed stream, where the inlet is configured as a burner 40 through which the feed stream is introduced into the reactor chamber via a conduit 2, and the oxygen-containing oxidant stream via a conduit 3. The burner flame is not shown in the figure for reasons of clarity. It is optionally possible to introduce a moderator stream comprising steam and/or carbon dioxide into the oxidation reactor via conduit 2 or conduit 3 or a separate conduit which is not shown, or a combination of at least two of these conduits. In the reactor chamber, the feed stream is reacted with the oxygen-containing oxidant stream under conditions of noncatalytic partial oxidation (POX). The product stream formed here is discharged from the oxidation reactor 1 via an outlet 4 mounted at an outlet end of the reactor shell 10. All the described constituents of the oxidation reactor 1 have gastight connections to one another and are fluidically connected.

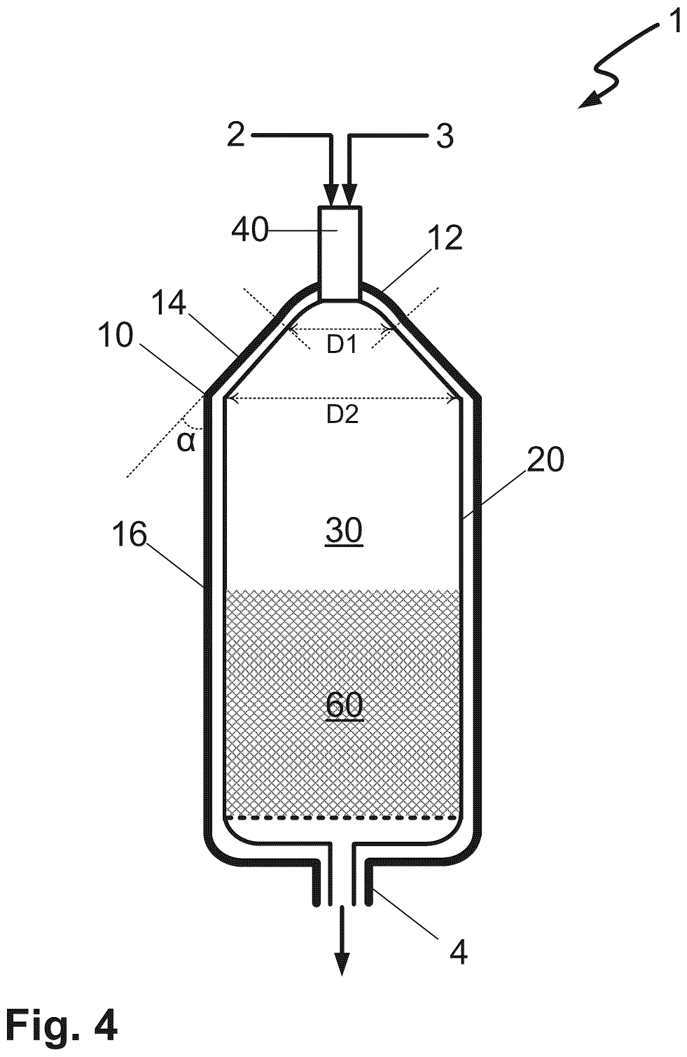

FIG. 4 shows a schematic diagram of a third configuration of the oxidation reactor according to the invention (autothermal reformer). The configuration of the oxidation reactor 1 as ATR which is shown in FIG. 4 corresponds largely to the configuration shown in FIG. 3, except that a bed 60 of an ATR catalyst is now disposed in the lower portion of the reactor chamber 30. For operation of the oxidation reactor as an autothermal reformer, as well as the oxygen-containing oxidant, steam is introduced into the oxidation reactor via conduit 2 or conduit 3 or a separate conduit which is not shown, or a combination of at least two of these conduits.

In further examples, in the oxidation reactors shown in FIGS. 3 and 4, the first section (a1) is of hemispherical configuration (not shown). Such a geometry exerts the smallest loads and forces on the inner refractory lining.

In further examples, in the oxidation reactors shown in FIGS. 3 and 4, the frustoconical second section (a2) has a slope angle between 5° and 30° inclusive, preferably between 10° and 20° inclusive, relative to the longitudinal axis, where the end values mentioned are included in the ranges of values (not shown). Studies show that, by virtue of these slope angles of the frustocone, the volume of the reactor is increased and, at the same time, the forces and loads on the refractory protective layer can be minimized.

In further examples, in the oxidation reactors shown in FIGS. 3 and 4, the frustoconical second section (a2) has an internal diameter D1 at its narrow end and an internal diameter D2 at its wide end, where the ratio D1/D2 is between 0.7 and 0.9, preferably between 0.75 and 0.85 (not shown). Studies show that these length ratios offer particular benefits.

In further examples, in the oxidation reactors shown in FIGS. 3 and 4, the slope of the dome-shaped first section corresponds to the slope of the frustoconical second section at a transition site of sections (a1) and (a2) (not shown). In this way, vertices are avoided in the reactor shell and the inner refractory protective layer, which increases the mechanical stability of the apparatus and minimizes thermal stress at the joining site of sections (a1) and (a2).

In further examples, in the oxidation reactors shown in FIGS. 3 and 4, the reactor shell is surrounded by at least one cooling zone by means of which at least one section of the reactor shell is coolable by means of a fluid cooling medium (not shown). In this way, control of the oxidation reactor temperature is improved and the construction materials and components used in the oxidation reactor are subject to lower thermal stress.

In further examples, in the oxidation reactors shown in FIGS. 3 and 4, there are at least two cooling zones arranged along the longitudinal axis of the oxidation reactor (not shown). As a result, operation of the oxidation reactor can continue if, for example, merely an inspection or repair at a particular point in the reactor shell is required. In this case, it is only that cooling zone which surrounds the affected point in the reactor shell that is taken out of operation, and then disassembled. On completion of inspection or repair, this cooling zone is reassembled and put back into operation. Operation of the oxidation reactor can continue over the entire duration of the inspection or repair measures, such that production shutdowns are avoided.

In further examples, in the oxidation reactors shown in FIGS. 3 and 4, a common cooling medium is used, which flows through all cooling zones (not shown), preferably with use of water as common cooling medium. Water is available in sufficient volume and quality at most locations, is nontoxic, and has advantages if cooling is to be implemented in the form of evaporative cooling in the particular cooling zone. The use of a common cooling medium additionally simplifies the configuration of the coolant circuit.

In further examples, in the oxidation reactors shown in FIGS. 3 and 4, the at least two cooling zones are operable separately and can be assembled and disassembled separately. As a result, in one example, operation of the oxidation reactor can continue if, for example, merely an inspection or repair at a particular point in the reactor shell is required. Operation of the oxidation reactor can continue over the duration of the inspection or repair measures, such that production shutdowns are avoided.

In further examples, the oxidation reactor shown in FIG. 3 is used for the noncatalytic partial oxidation (POX) of a feed stream containing hydrocarbons to a product stream containing hydrogen and carbon oxides.

In further examples, the oxidation reactor shown in FIG. 3 is used for the partial oxidation of an ammonia-containing feed stream to a hydrogen- and nitrogen-containing product stream.

In a further example, the oxidation reactor shown in FIG. 4 is used for the autothermal reforming (ATR) of a feed stream containing hydrocarbons to a product stream containing hydrogen and carbon oxides.

In a further example, the oxidation reactor shown in FIG. 4 is used for the autothermal reforming (ATR) of an ammonia-containing feed stream to a hydrogen- and nitrogen-containing product stream.

Further working examples of the invention include a process for producing a product stream containing hydrogen and carbon oxides from a feed stream containing hydrocarbons and an oxygen-containing oxidant stream, comprising the following steps:
(a) providing an oxidation reactor according to claims 1 to 9;
(b) introducing the feed stream containing hydrocarbons, the oxygen-containing oxidant stream and an optional moderator stream via the burner into the reaction chamber;
(c) converting the feed stream containing hydrocarbons and the oxygen-containing oxidant stream in the burner and/or in the reactor chamber under conditions for noncatalytic partial oxidation (POX);
(d) discharging the product stream containing hydrogen and carbon oxides via the outlet.

Further working examples of the invention include a process for producing a product stream containing hydrogen and carbon oxides from a feed stream containing hydrocarbons and an oxygen-containing oxidant stream, comprising the following steps:
(a) providing an oxidation reactor according to claim 10;
(b) introducing the feed stream containing hydrocarbons, the oxygen-containing oxidant stream and an optional moderator stream via the burner into the reaction chamber;
(c) converting the feed stream containing hydrocarbons and the oxygen-containing oxidant stream in the burner and/or in the reactor chamber and/or in the catalyst bed under conditions for autothermal reforming (ATR);
(d) discharging the product stream containing hydrogen and carbon oxides via the outlet.

Further working examples of the invention include a process for producing a product stream containing hydrogen and nitrogen from an ammonia-containing feed stream and an oxygen-containing oxidant stream, comprising the following steps:
(a) providing an oxidation reactor according to claims 1 to 9;
(b) introducing the ammonia-containing feed stream, the oxygen-containing oxidant stream and an optional moderator stream via the burner into the reaction chamber, and optionally introducing a steam stream into the reaction chamber;
(c) converting the ammonia-containing feed stream and the oxygen-containing oxidant stream in the burner and/or in the reactor chamber under conditions for noncatalytic partial oxidation of ammonia;
(d) discharging the product stream containing hydrogen and nitrogen via the outlet.

Further working examples of the invention include a process for producing a product stream containing hydrogen and nitrogen from an ammonia-containing feed stream and an oxygen-containing oxidant stream, comprising the following steps:
(a) providing an oxidation reactor according to claim 10;
(b) introducing the ammonia-containing feed stream, the oxygen-containing oxidant stream and an optional moderator stream via the burner into the reaction chamber;
(c) converting the ammonia-containing feed stream and the oxygen-containing oxidant stream in the burner and/or in the reactor chamber and/or in the catalyst bed under conditions for autothermal reforming (ATR);
(d) discharging the product stream containing hydrogen and nitrogen via the outlet.

Alterations to the above-described embodiments or configurations of the present disclosure are possible without departing from the scope of the present disclosure defined by the accompanying claims. Expressions such as “including”, “comprising”, “containing”, “have” and “is” that are used for description and claiming of the present disclosure shall be considered to be non-exclusive, meaning that they allow for the presence of articles, components or elements that are not explicitly described. References to the singular shall be considered also to refer to the plural in the absence of explicit indications to the contrary in the particular case.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing i.e. anything else may be additionally included and remain within the scope of “comprising.” “Comprising” is defined herein as necessarily encompassing the more limited transitional terms “consisting essentially of” and “consisting of”; “comprising” may therefore be replaced by “consisting essentially of” or “consisting of” and remain within the expressly defined scope of “comprising”.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

All references identified herein are each hereby incorporated by reference into this application in their entireties, as well as for the specific information for which each is cited.

### LIST OF REFERENCE NUMERALS

[1] oxidation reactor
[2] conduit
[3] conduit
[4] outlet
[10] reactor shell, cylindrical third section
[12] reactor shell, dome-shaped first section
[14] reactor shell, frustoconical second section
[16] reactor shell, cylindrical third section
[20] protective layer (refractory lining)
[30] void volume (reactor chamber)
[40] burner
[50] burner flame
[60] ATR catalyst bed

1. An oxidation reactor for partial oxidation of a feed stream with an oxygen-containing oxidant stream to give a hydrogen-containing product stream, comprising:
(a) a pressure-rated reactor shell having a longitudinal axis and consisting of a metallic material, where the reactor shell comprises the following sections along the longitudinal axis:
(a1) a dome-shaped first section,
(a2) a frustoconical second section,
(a3) a cylindrical third section,
wherein first section has a gastight connection to the second section, and the second section has a gastight connection to the third section;
(b) at least one protective layer of a refractory and corrosion-resistant material, mounted within the reactor shell;
(c) a void volume as reaction chamber disposed within the protective layer;
(d) an inlet for the feed stream, mounted at the pole of the first section, where the inlet is configured as a burner through which the feed stream, the oxygen-containing oxidant stream and a moderator stream can be introduced into the reactor chamber;
(e) an outlet disposed at an outlet end of the reactor shell, through which the product stream can be discharged.

2. The oxidation reactor according to claim 1, wherein the first section is of hemispherical configuration.

3. The oxidation reactor according to claim 1, wherein the frustoconical second section has a slope angle between 5° and 30° inclusive relative to the longitudinal axis.

4. The oxidation reactor according to claim 1, wherein the frustoconical second section has a first internal diameter D1 at a narrow end and a second internal diameter D2 at a wide end, where the ratio D1/D2 is between 0.7 and 0.9.

5. The oxidation reactor according to claim 1, wherein the slope of the dome-shaped first section corresponds to the slope of the frustoconical second section at a transition site of the first section and the second section.

6. The oxidation reactor according to claim 1, wherein the reactor shell is surrounded by at least one cooling zone by means of which at least one section of the reactor shell is coolable by means of a fluid cooling medium.

7. The oxidation reactor according to claim 1, wherein there are at least two cooling zones disposed along the longitudinal axis of the oxidation reactor.

8. The oxidation reaction according to claim 7, wherein a common cooling medium flows through the at least two cooling zones.

9. The oxidation reactor according to claim 7, wherein the at least two cooling zones are operable separately and can be assembled and disassembled separately.

10. The oxidation reactor according to claim 1, wherein a portion of the reactor chamber is filled with a bed of a solid particulate catalyst active in respect of autothermal reforming.

11. A process for producing a product stream containing hydrogen and carbon oxides from a feed stream containing hydrocarbons and an oxygen-containing oxidant stream, comprising the following steps:
(a) providing an oxidation reactor according to claim 1;
(b) introducing the feed stream containing hydrocarbons, the oxygen-containing oxidant stream and a moderator stream via the burner into the reaction chamber;
(c) converting the feed stream containing hydrocarbons and the oxygen-containing oxidant stream in the burner and/or in the reactor chamber under conditions for noncatalytic partial oxidation; and
(d) discharging the product stream containing hydrogen and carbon oxides via the outlet.

12. The process for producing a product stream containing hydrogen and carbon oxides from a feed stream containing hydrocarbons and an oxygen-containing oxidant stream, comprising the following steps:
(a) providing an oxidation reactor according to claim 10;
(b) introducing the feed stream containing hydrocarbons, the oxygen-containing oxidant stream and a moderator stream via the burner into the reaction chamber;
(c) converting the feed stream containing hydrocarbons and the oxygen-containing oxidant stream in the burner and/or in the reactor chamber and/or in the catalyst bed under conditions for autothermal reforming; and
(d) discharging the product stream containing hydrogen and carbon oxides via the outlet.

13. A process for producing a product stream containing hydrogen and nitrogen from an ammonia-containing feed stream and an oxygen-containing oxidant stream, comprising the following steps:
(a) providing an oxidation reactor according to claim 1;
(b) introducing the ammonia-containing feed stream, the oxygen-containing oxidant stream and a moderator stream via the burner into the reaction chamber;
(c) converting the ammonia-containing feed stream and the oxygen-containing oxidant stream in the burner and/or in the reactor chamber under conditions for noncatalytic partial oxidation of ammonia; and
(d) discharging the product stream containing hydrogen and nitrogen via the outlet.

14. A process for producing a product stream containing hydrogen and nitrogen from an ammonia-containing feed stream and an oxygen-containing oxidant stream, comprising the following steps:
(a) providing an oxidation reactor according to claim 10;
(b) introducing the ammonia-containing feed stream, the oxygen-containing oxidant stream and a moderator stream via the burner into the reaction chamber;
(c) converting the ammonia-containing feed stream and the oxygen-containing oxidant stream in the burner and/or in the reactor chamber and/or in the catalyst bed under conditions for autothermal reforming; and
(d) discharging the product stream containing hydrogen and nitrogen via the outlet.
